(19) United States
(12) Patent Application Publication
(10) Pub. No.: US 2023/0362578 A1
(43) Pub. Date: Nov. 9, 2023

(54) SYSTEM FOR REPRODUCING SOUNDS WITH VIRTUALIZATION OF THE REVERBERATED FIELD

(71) Applicant: Jean-Marc SIOU, Paris (FR)

(72) Inventor: Jean-Marc SIOU, Paris (FR)

(21) Appl. No.: 18/044,972

(22) PCT Filed: Sep. 9, 2021
(86) PCT No.: PCT/EP2021/074869

§ 371 Date: Mar. 10, 2023

(30) Foreign Application Priority Data
Sep. 11, 2020 (FR) 2009250
Mar. 24, 2021 (FR) 2102962

(51) Int. Cl. H04S 7/00; H04R 5/02

(52) U.S. Cl. CPC H04S 7/305; H04R 5/023; H04R 2499/13

(57) ABSTRACT

The system for reproducing sounds (100) comprises at least four electroacoustic transducers, which each receive an audio signal and convert it into a sound signal, and a listening area for a single listener. Two of the four transducers, called front transducers (105), are placed mutually symmetrically with respect to a median vertical plane, and are oriented so as to each emit an audio wave towards the listening area, and two of the four transducers, called rear transducers (107), are placed mutually symmetrically with respect to said median vertical plane and are oriented so as to each emit a sound wave towards said listening area, so as thus to form two pairs of transducers that are mutually symmetric with respect to said median vertical plane. The single listener positions themselves such that they face the front transducers (105) and have their back to the rear transducers (107).

### FIELD

### Field of the Invention

The present invention relates to sound reproduction systems.

More specifically, the invention relates to a sound reproduction system simulating the phenomenon of reverberation, for example fitted to a seat.

### TECHNOLOGICAL BACKGROUND

In a closed environment, such as a concert hall or cinema, sound waves not only propagate in a straight line from their source, but also undergo multiple reflections from the walls, the ceiling and the various objects present in the closed environment. The sound perceived by the listener is therefore the superposition of direct waves, called free field, and reverberated waves, constituting the diffuse field. The listener then has the sensation of being “enveloped” by the sound, which comes to him from multiple directions.

The phenomenon of reverberation is essential in the perception of sound. In particular, it allows the listener to locate the soundstage with good precision. The reverberation on the walls of an interior space thus gives indications on the distance source—listener, but also the distances source-walls or walls-listener.

However, this phenomenon is closely dependent on the place of listening and it can be at the origin of undesirable acoustic defects and notable differences between the sound perceived in the room (or the place) of recording and the reproduced sound. It is therefore both desirable and inconvenient because it is difficult to control.

The sounds that are perceived as contributing to the reverberation are those that arrive with a sufficient delay relative to the direct sound, allowing the brain to separate the direct sounds from the reverberated sounds as shown in FIG. 5. The delay necessary for the sound to be in the reverberation zone depends on the frequency and it is all the less as the frequency is high.

For example, a sound with a frequency of the order of 500 Hz resulting from a reflection on an obstacle placed so that its path is elongated by less than 1.8 m compared to the sound coming in a straight line to the listener will be confused with the latter, whereas it will be perceived as participating in the phenomenon of reverberation if its path is extended by a distance greater than 1.8 m. At 60 Hz, up to an extension of the path of approximately 18 meters, the direct sound and the reflected sound will be confused by the listener, causing significant deformation. The different components of a sound are therefore significantly modified between the emission and the listener by the listening room due to the different obstacles found there, the low frequencies being impacted by obstacles located in a radius around of the source greater than the high frequencies.

At low frequencies, the waves thus easily find obstacles resulting in the creation of stationary waves and comb filtering, unpleasant for the listener, except if one has a very large listening room, with in particular a very high ceiling.

It is possible to overcome the acoustic defects of a room of more common dimensions, but this requires an acoustic study specific to this room and the implementation of expensive acoustic treatments which are too expensive for private use.

In the field of sound reproduction, for example the broadcasting of a stereophonic recording, it is known to use two electroacoustic transducers, such as loudspeakers, placed on either side of the user, either facing him or on his sides.

The most common loudspeakers have three channels, dedicated respectively to the low, medium and high audible frequencies. The frequency ranges emitted by these three channels overlap two by two, which makes listening at short distance unpleasant due to the phase difference between two signals of the same frequency emitted by two different channels. The perception of this phase shift decreases with the distance from the loudspeakers. Loudspeakers are therefore generally used at a distance of one to several meters and their use at a listening distance of less than one meter is not common practice for the person skilled in the art.

The sound perceived by the listener results from the direct emission by the loudspeakers and the multiple reflections in the room in which the listening of a recording is carried out.

If one chooses to limit the phenomenon of reverberation in the listening room as much as possible, for example by means of appropriate acoustic insulation, in the case of such stereophonic listening, the delay between the sound coming from the loudspeaker left and that of the right speaker allows to reconstruct only roughly the original spatial scene.

Even with multi-channel recording and sound reproduction by a plurality of loudspeakers, the reconstruction of the original soundstage remains imprecise.

The phenomenon of reverberation is necessary for an accurate reconstruction and for the listener to perceive the sound as natural.

However, the phenomenon of reverberation in the listening room is specific to the listening room and is not always controlled or controllable. The sound perceived by the listener is therefore not faithful to the situation that the sound engineer in charge of the mixing would have liked to recreate, and/or the quality of the perceived sound is not controlled.

Last, the direct and/or reflected waves emitted by the two loudspeakers can interfere with each other. Certain frequencies are therefore significantly amplified or attenuated in the sound received by the listener compared to the original sound, as if a comb filter was applied to the original sound signal.

Such a situation therefore does not allow high quality listening. It is therefore necessary for quality listening both to have a reverberation phenomenon and to exercise as accurate control as possible on this phenomenon.

If one wishes to overcome the specificities of the listening room, it is possible to carry out binaural listening by means of earphones. The disadvantage of such a simple stereophonic reproduction of sound is that the perceived sound lacks naturalness, spatial depth, since the phenomenon of reverberation is absent and in pure binaural listening, the sounds summed in phase are perceived by the listener as coming from a virtual source above his head.

It is known to use more than two loudspeakers so that the sound reproduced, actually perceived by the listener, approaches the sound that he would have perceived directly.

Document EP0036337B1 is an example in which at least two pairs of loudspeakers are placed around the listeners head, in the half-space facing the listener and/or in the half-space behind the listener. The sound emitted by the second pair of electro-acoustic transducers is controlled by an electronic system and the superposition of the sounds emitted by the two pairs of loudspeakers allows the listener to locate the source of the sound at a point in the half-space in front of him or behind him which depends on the values of the input parameters of the electronic system. The device provides the possibility of superimposing waves that simulate natural reverberation, having a delay of 10 to 50 ms with respect to the initial wave, to make the sound thus recreated as realistic as possible. However, the reverberation is simulated by superimposing a delayed signal and the signal emitted by the loudspeakers, so that the direct field and the simulated reverberant field are emitted by the same loudspeaker. The perceived sound therefore always lacks naturalness insofar as it is not perceived as enveloping by the listener.

Moreover, in this device, all the loudspeakers are in the same horizontal plane, which does not make it possible to overcome the comb filtering effect mentioned above.

In addition, the front speakers partially hide the listeners field of vision. Such a device is therefore not necessarily suitable for equipping a seat in a room such as a cinema room or for broadcasting a recording for a person observing a visual scene, for example a painting in a museum.

Finally, this system is designed to choose the localization perceived by the listener of the sound source, that is to say so that, on the basis of the reproduced sound, the listener positions the different sound objects of the soundstage as faithfully as possible to the initial scene. The reproduction of the spatial aspect of the original sound is therefore optimized, but on the other hand, this system is not optimized so that the reproduced sound is as faithful as possible regarding all its other aspects to the sound recorded in a given recording room or to the sound as it would have been perceived in a room precisely acoustically adapted to the sound stage to be reproduced.

Patent application WO 2018/194501 A1 describes a sound reproduction system making it possible to overcome the limitations of conventional stereophonic reproduction—in particular to recreate the depth of the soundstage—by the use of digital signal processors.

A plurality of complementary loudspeakers can be provided and arranged at will in the room, around the listener. The signals supplying the various loudspeakers are calculated by a digital signal processing system from the left and right sound signals (L and R) recorded in stereo. In order to reproduce the acoustics of a room of the listeners choice, for example that of the recording room, different combinations of the L and R signals can be envisaged: sum, difference, application of a gain on the one or the other, of a delay in one or the other, etc.

The frequency spectrum of the delayed signals is controlled to take into account the damping of certain frequencies due to a reflection on an obstacle and on the path of the wave. In this way, the listeners brain analyses the superposition of signals emitted by each of the loudspeakers as coming from a single source and with reverberation

Each loudspeaker simultaneously emits a direct field and a simulated reverberant field. In a device containing two front speakers, the sound is therefore not perceived as enveloping.

In this device, the impact of the position of the listener relative to the loudspeakers is not taken into account. Typically, the device can be implemented in an audio headset version as well as to equip a room accommodating several listeners. It is therefore clear that such a device does not make it possible to overcome the reverberation of sound by the listening room, nor to obtain identical listening at all points of the room.

Devices of the helmet type, such as the device described by patent U.S. Pat. No. 8,442,244 B1 can be envisaged to overcome this defect. In the latter case, the helmet is acoustically transparent, which does not allow good acoustic insulation of the listener. Headphones can also be a source of discomfort for the listener, especially for listening for a long period of time.

Seats equipped with sound reproduction systems are also known. Document WO9930532A1 thus discloses a seat equipped with a multi-channel audio system that can be used with a screen to create a “virtual reality” environment, for example for video games. At least one loudspeaker is placed on each side of the user. In addition to these two loudspeakers, a loudspeaker emitting at frequencies below 10 kHz is placed facing the user in the median plane of the seat and an additional high-frequency loudspeaker (>4 kHz) can be placed behind the listener or above their head to create a reverb effect. The distribution of the electrical signals between the various loudspeakers can be managed by a digital signal processor (Digital Signal Processing or DSP).

However, in the seat described by WO9930532A1, the two front loudspeakers are placed in the seat base, so that the ears of the listener are not in the axis or close to the axis of emission of these loudspeakers. The listener is therefore not in an optimal listening position relative to them. In particular, the sound wave does not reach the listeners frontal lobe before it reaches their ears, a necessary condition for a monophonic sound to be perceived as coming from a source in front of the listeners head.

In addition, the emission being in the direction of the ceiling, the wave is reflected on it, which gives rise to an unwanted and uncontrolled reverberation phenomenon.

Last, the seat does not make it possible to limit the perception by the user of undesirable sound waves coming from the left or the right of the latter, or even of the reflections of the sound waves emitted by the various loudspeakers of the device on the obstacles to the left or right of the user. Such a seat is therefore not suitable for equipping a room such as a cinema room or for sound reproduction that is slightly disturbed by external noise.

The invention thus aims to propose a sound reproduction system making it possible to overcome the acoustic characteristics of the listening room, so as to obtain in particular a sound perceived by the listener as faithful as possible to the sound scene to be reproduced, which coloration depends for example on the recording room in the case of a recording in a concert situation.

### SUMMARY OF THE INVENTION

Thus, the invention relates to a sound reproduction system comprising at least four electroacoustic transducers each receiving an audio signal and converting it into a sound signal, and comprising a listening area for a single listener, in which:
two of the four transducers, called front transducers, are placed symmetrically to each other with respect to a median vertical plane, and oriented so as to each emit a sound wave towards the listening area,
two of the four transducers, called rear transducers, are placed symmetrically to each other with respect to the median vertical plane and oriented so as to each emit a sound wave towards the listening area,
the four transducers, front and rear, thus form two pairs of transducers symmetrical to each other with respect to said median vertical plane, each pair of transducers comprising a front transducer and a rear transducer,
the single listener is to be placed facing the front transducers and back to the rear transducers.

Thanks to this arrangement, the single listener receives signals from the four transducers which can be controlled, the front transducers allowing stereophonic listening and the rear transducers being possibly dedicated to the reproduction of a simulated reverberant field, possibly flawless.

Depending on various aspects, it is possible to provide one and/or the other of the provisions below.

In a particular embodiment, each of the four transducers is a directional sound source characterized by a main emission axis secant with the median vertical plane. Moreover, for each of the pairs of transducers, the sound signal emitted by said rear transducer simulates a reverberant field corresponding to the sound signal emitted by said front transducer. In addition, the four transducers are included in a parallelepiped volume with a width of less than 200 cm, a length of less than 200 cm and a height of less than 200 cm, and the distance measured horizontally between the pairs of transducers is greater than the distance measured horizontally between the two ears of the single listener.

Thanks to this arrangement, the listener is placed in a listening position close to the four transducers, making it possible to exploit the psychoacoustic effects so that the perceived soundstage is as faithful as possible to the soundstage which gave rise to the recording. In particular, since the intensity of any existing reverberant field is generally naturally weak, this particular positioning of the rear loudspeakers in a precise area close to the listener makes it possible to ensure that the intensity of the reverberant field in the listening room is lower than that of the reverberant field simulated by the rear loudspeakers in the listening area and that the listening to the rear loudspeakers takes place in the near field. Thanks to this choice of positioning the rear loudspeakers, the reverberant field simulated by these loudspeakers masks the reverberant field due to the elements surrounding the audio system. Then, the listener will be allowed to reconstruct the reverberation phenomenon corresponding to the soundstage reproduced by the front loudspeakers essentially based on the audio signals from the two rear loudspeakers, relatively independently of the listening room.

Furthermore, the flawless transmission of the direct field and the simulated reverberant field through separate loudspeakers, in front of and behind the listener, provides the listener with a perception of natural and enveloping sound, although listening takes place in the near field.

The sound reproduction system is placed so that the ears of the listener in the listening area are not in contact with the sound reproduction system, which is therefore not a traditional headset and allows quality listening, little impacted by parasite sound sources but without the discomfort associated with wearing a headset.

According to one embodiment, in the sound reproduction system, the greater of the two distances among the distance measured horizontally between the two front transducers and the median plane and the distance measured horizontally between the two rear transducers and the median plane, and the distance measured in the front-to-rear direction between the front transducer and the rear transducer of each of said pairs of transducers are in a ratio of the order of 0.7.

Thanks to this arrangement, the listening area, corresponding to the area of overlap between the four beams of sound waves coming from the four transducers, occupies a volume of the order of that of the listeners head. The inventor has observed that this particular range of spatial configuration of the sound reproduction system provides the listener with a particularly natural and enveloping sensation of sound.

According to one embodiment, in the sound reproduction system, the emission axes of the front loudspeakers intersect at a point of intersection of the emission axes of the front loudspeakers, the front loudspeakers are each delimited by a flat front face on the emission side and the point of intersection of the emission axes of the front loudspeakers forms with the points of intersection of each of the emission axes of each front loudspeaker with the flat front face of this front loudspeaker an isosceles triangle which equal angles are between 50° and 70°.

The inventor has observed that this particular range of spatial configuration of the sound reproduction system provides the listener with a particularly natural and enveloping sensation of sound.

In one embodiment, each of the pairs of transducers of the sound reproduction system is integrated into a housing comprising one or more recesses in which said front and rear transducers of said pair of transducers are placed, and of which at least one part of the walls is covered with an acoustically insulating material.

Thanks to this arrangement, the positioning of the two transducers of a pair of transducers with respect to each other can be adjusted and the transducers and their positioning are protected from impacts.

In addition, the insulation of at least part of the walls of the compartment makes it possible to partially isolate the listening area from parasite sound sources and any uncontrolled reverberation phenomena on these walls.

According to one embodiment, each of the housings of the sound reproduction system is mounted on at least one support stand, optionally adjustable in height.

Thanks to this arrangement, a range of possible heights for positioning the listening area can be accessed, which depends on the height (heights in the adjustable case) of the support stand and the floor space requirement of the sound reproduction system is reduced.

Thanks to this arrangement, the sound reproduction system can also be linked to a seat, for example on armrests, on a backrest or on any other suitable element of the seat. It can also be simply moved on the floor from place to place.

According to one embodiment, the reproduction system further comprises a rear wall, and two side walls extending in depth in front of the rear wall and in height to a height lower than that of the upper edge of the rear wall, and each comprising at least one recess so that the walls each form a housing in which one of said pairs of transducers is placed. The rear wall and the side walls form a symmetrical assembly with respect to the median vertical plane. The listening area is the empty volume between the side walls at a height higher than the upper edges of the side walls and lower than the upper edge of the rear wall. Each of the front transducers emits a sound wave towards the listening area in an emission cone entirely intercepted by the head of the listener placed in the listening area and/or by the rear wall and/or by the side walls, and each of the rear transducers emits a sound wave towards the listening area in an emission cone entirely intercepted by the listeners head placed in the listening area and/or by the side walls.

Thanks to these arrangements, the listener is placed in a near-field listening situation with respect to the various loudspeakers and the uncontrolled reverberation phenomenon associated with the listening room in which the sound reproduction system is located is limited thanks to the different rear and side walls. The listener perceives the direct sound from the various loudspeakers and the real reverberant field is masked by this direct field. It is then possible to recreate using part of the loudspeakers a virtual reverberant field, which will constitute the reverberant field perceived by the listener.

In a particular embodiment, the front transducers of the sound reproduction system are placed at a distance from the listener allowing the listening of the direct field of these front transducers, that is to say a distance less than the critical distance at which the intensities of the direct field and the diffuse field are equal.

According to one embodiment, the distance between the listener and said front transducers is less than 1 m.

Such a distance is unusual for positioning loudspeakers in a room when enveloping sound is desired, but it generally allows the near-field listening that is precisely necessary to obtain the quality of sound reproduction aimed for by the invention.

According to one embodiment, at least one of the compartments of a housing of the sound reproduction system comprises a device for constraining in a fixed or adjustable manner the orientation of the emission axis of at least one of said transducers.

Thanks to this arrangement, the user or an operator can adjust the orientation of the two transducers of a pair of transducers relative to each other and/or relative to another pair of transducers, in particular for a given listener or in order to choose the height of the listening area relative to the floor, for example.

According to one embodiment, the sound reproduction system comprises a seat comprising at least one seat base, optionally covered at least partially with a sound-insulating material, so that the listening area is above the seat base and that each of the housings is linked to the seat.

Thanks to this arrangement, the optimal placement of the listener in relation to the listening area is facilitated and listening can be done over long periods of time without excessive fatigue for the listener.

The at least partial acoustic insulation of the seat base makes it possible to limit unwanted reverberation phenomena on this seat base and to further improve the precision of the reproduction of the soundstage.

According to one embodiment, the seat that comprises the sound reproduction system further comprises armrests, to which the housings of the sound reproduction system are attached, optionally in a removable manner.

Thanks to this arrangement, any seat provided with armrests can be transformed in a reversible manner into a quality audio listening seat according to the invention, without it being necessary to purchase a specific seat for the sound reproduction system, the positioning of the boxes on the armrests being naturally optimal for the listener and the armrests participating in the sound insulation with respect to parasite sound sources.

In particular, optional implantation inserts for supporting the housing, placed on the armrests, can allow stable, simple and quick installation on any type of seat and offer height adjustment around the listener.

According to one embodiment, the seat included in the sound reproduction system comprises at least one additional infra-bass transducer placed in the seat base.

Thanks to this arrangement, the reproduction of infra-bass frequencies, whose precise positioning of the source around the listener does not matter for the localization of the soundstage, can be of good quality.

According to one embodiment, a seat included in the sound reproduction system comprises a backrest forming a rear wall optionally covered with an acoustically insulating material.

Thanks to this arrangement, the listener is better isolated from uncontrolled reverberation phenomena that would reach him from behind.

According to one embodiment, the inclination of the backrest is adjustable and/or the position of the seat is adjustable in depth and/or in height.

Thanks to this arrangement, the placement of the listener in relation to the listening area can be adjusted according to the height of the listener.

According to one embodiment, the housings of the sound reproduction system are linked, optionally in a removable manner, to a wall of a building forming a rear wall, optionally covered with an acoustic insulating material.

Thanks to this arrangement, it is possible to form a listening area no footprint on the floor. For example, a listening zone can be formed for a listener placed upright in a museum or elsewhere, or for a listener lying in bed.

In addition, if the rear wall is insulated, listening is not disturbed by uncontrolled reverberation phenomena towards the rear of the listener or by parasite sound sources emitting sound waves that could propagate and reach the listener directly from behind.

According to one embodiment, the housings of the sound reproduction system can be folded down against a rear wall to which the reproduction system is linked, when these housings are not used for the reproduction of sounds.

Thanks to this arrangement, the space requirement of the sound reproduction system is reduced when it is not in use.

According to one embodiment, the sound reproduction system further comprises two additional low-frequency transducers placed symmetrically to each other in the housings.

This arrangement makes it possible to bring the source of the low frequencies as close as possible to the single listener, so that they are perceived as quickly as possible to better mask the reverberant field, which is particularly intense in the low frequencies, since they correspond to high wavelengths.

According to one embodiment, the sound reproduction system comprises an upper wall secured to the housings extending in a horizontal plane above the head of the user and covered with an acoustic insulating material.

Thanks to this arrangement, the listening is not disturbed by uncontrolled reverberation phenomena on the ceiling of the room or by parasite sound sources emitting sound waves which could propagate and reach the listener from above their head.

According to one embodiment, the sound reproduction system comprises at least one signal processing device, such that the audio signal received by the rear transducer of each of said pairs of transducers is generated by means of the signal processing device (DSP, “digital signal processor”) from the same audio signal as that from which the audio signal received by said front transducer of said pair of transducers is formed.

Thanks to this arrangement, the sound signals emitted by a front transducer and the rear transducer are linked, which makes it possible to simulate the reverberant field in a controlled manner, i.e. independently of the room in which the sound system sound reproduction is placed, but dependent on the settings chosen at the DSP level.

According to one embodiment, in the sound reproduction system, the audio signal at the input of the rear transducer of each of the pairs of transducers is delayed relative to the audio signal from which the audio signal received by the front transducer of said pair of transducers is formed.

Thanks to this arrangement, the sound signals emitted by the rear transducers simulate a field actually perceived as a reverberant field associated with the free field emitted by the front transducers, and the control of the delay makes it possible to simulate a particular acoustic environment.

According to one embodiment, in the sound reproduction system, the amplitude spectrum and/or the phase spectrum of said audio signal at the input of the rear transducer of each of the pairs of transducers is modified with respect to the corresponding spectrum of the audio signal from which the audio signal received by the front transducer of the same pair of transducers is formed.

Thanks to this arrangement, it is possible to give a particular coloration to the reverberant field simulated by the rear transducers and, for example, to faithfully reproduce the acoustics of a particular recording room.

According to one embodiment, the sound reproduction system comprises a memory storing predefined parameters chosen according to the acoustics of a given room, the parameters being used by the signal processing device for modifying the amplitude spectrum and/or of the phase spectrum of the audio signal at the input of the rear transducer of each of the pairs of transducers.

Thanks to this arrangement, acoustic ambiences can be stored and selected by the user at the time of listening or by an operator at the time of adjusting the system.

According to one embodiment, the sound reproduction system further comprises a second digital signal processing device and the audio signal received by a front loudspeaker is received at the output of the second digital signal processing device.

Thanks to this arrangement, it is in particular possible to correct any intrinsic defects of the front loudspeakers so that the sound emitted by these loudspeakers is as faithful as possible to the sound which has been recorded.

According to one embodiment, the second digital signal processing device is suitable for correcting the non-linearity of at least one of the front transducers.

According to one embodiment, the front transducers of the sound reproduction system are coaxial with mechanically aligned phase.

The invention also relates to a room equipped with a plurality of sound reproduction systems.

The invention finally relates to a housing comprising one or more compartments suitable for receiving at least one front transducer and one rear transducer for a sound reproduction system.

### BRIEF DESCRIPTION OF THE DRAWINGS

Embodiments of the invention will be described below with reference to the drawings, briefly described below:

FIG. 1 shows a side view of the sound reproduction system according to one embodiment.

FIG. 2 shows a top view of the sound reproduction system of FIG. 1.

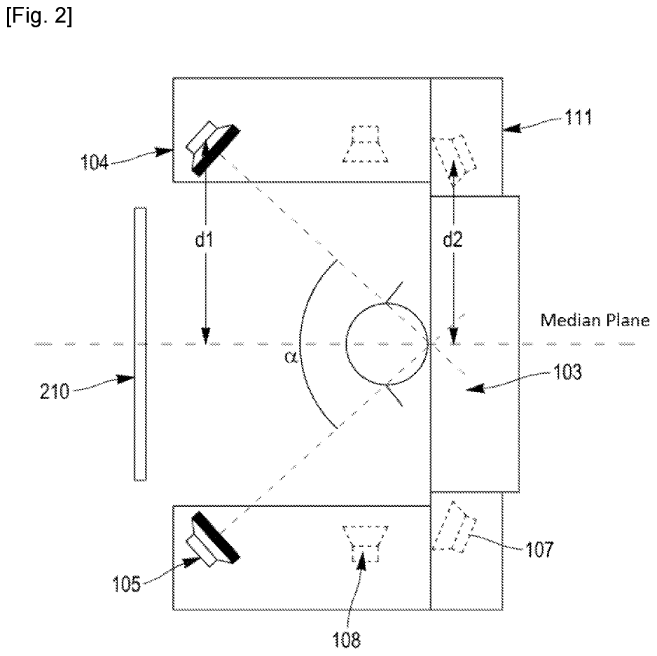

FIG. 3 shows a front view of the sound reproduction system of FIG. 1.

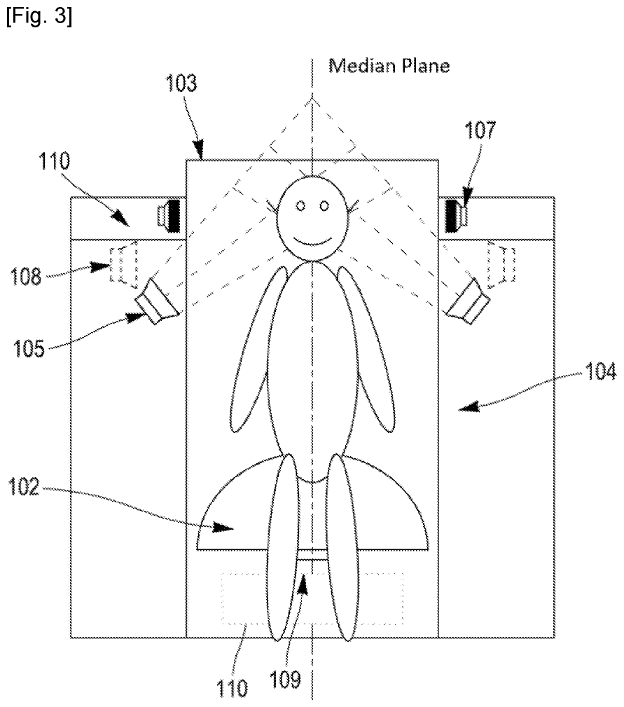

FIG. 4 is a block diagram of the audio signal processing chain in a particular embodiment.

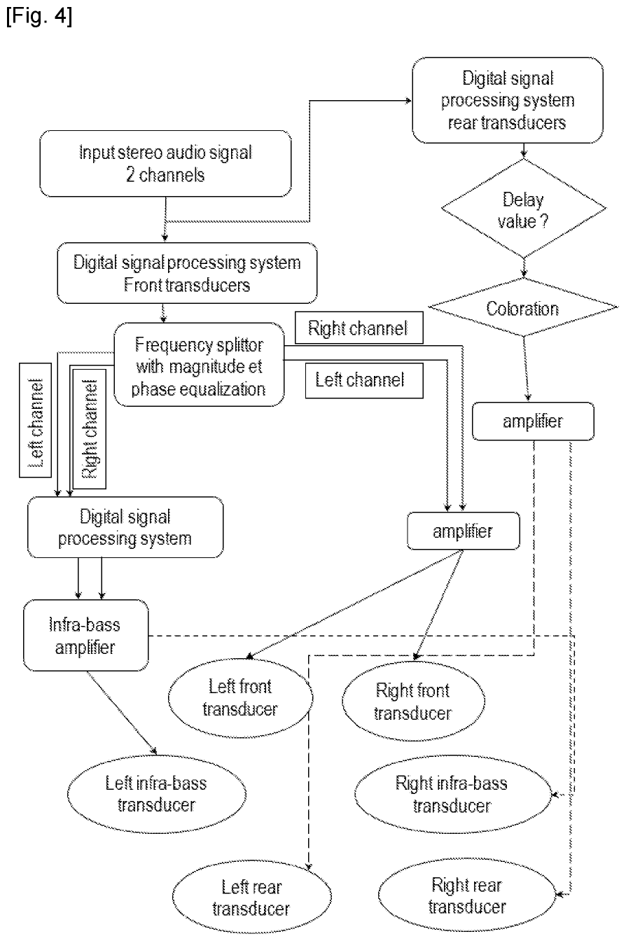

FIG. 5 represents the zones for which the direct sound and the sound reflected on an obstacle are perceived as merged or on the contrary separated, so that the listener perceives a phenomenon of reverberation, in the plane (frequency of a sound signal; delay of the sound reflected on the direct sound). This graph was obtained following studies carried out in an anechoic chamber at the National Audiovisual Institute (INA, France, work by Patrick Thévenot.)

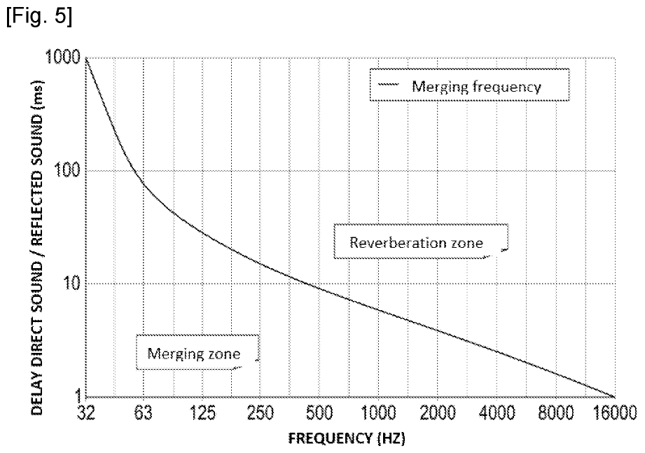

FIG. 6 represents the measurement of RT60 of a seat equipped with the invention. 6 RT60 is the time it takes for the sound pressure level to decrease by 60 dB, measured after the sound source has been turned off abruptly. The black and thicker curve indicates the RT60 reverberation time as a function of the frequency of a study room. 0 The thick gray curve indicates the RT60 reverberation time at the sound reproduction device in this same study room, without activation of the digital control of the reverberation zone (B). The thin gray curve corresponds to the reverberation time RT60 measured under the same conditions but with reverberation recreated virtually and set to 0.56 seconds.

FIG. 7 shows a housing comprising compartments in which are placed a set of electroacoustic transducers.

In the drawings, identical references designate identical or similar objects.

### DETAILED DESCRIPTION

The invention therefore relates to a sound reproduction system 100 comprising at least four electroacoustic transducers each receiving an audio signal and converting it into a sound signal, and comprising a listening area for a single listener, in which:
a. two of the four transducers, called front transducers, are placed symmetrically to each other with respect to a median vertical plane, and oriented so as to each emit a sound wave in the direction of the listening area,
b. two of the four transducers, called rear transducers, are placed symmetrically to each other with respect to the median vertical plane and oriented so as to each emit a sound wave in the direction of the listening area.

The four transducers, front and rear, thus form two pairs of transducers symmetrical to one another with respect to the median (or equivalently mediating) vertical plane, each pair of transducers comprising a front transducer 105 and a rear transducer 107.

The single listener is placed facing the front transducers and back to the rear transducers.

In a particular embodiment, each of the four transducers is a directional sound source characterized by a main emission axis secant with the median vertical plane.

Moreover, for each of the pairs of transducers, the sound signal emitted by said rear transducer 107 simulates a reverberant field corresponding to the sound signal emitted by the front transducer 105.

In addition, the single listener is placed in a listening position close to the four transducers, without the reproduction system directly touching the listeners ears as in conventional headphones:
a. the four transducers are included in a parallelepipedal volume with a width of less than 200 cm, a length of less than 200 cm and a height of less than 200 cm,
b. the distance measured horizontally between the pairs of transducers is greater than the distance measured horizontally between the two ears of the single listener.

The distance measured horizontally between the pairs of transducers is defined as the shortest distance between a point of one pair of transducers and a point of the second pair of transducers lying in the same horizontal plane.

This particular listening position makes it possible to exploit the psychoacoustic effects: in particular, as the intensity of the possibly existing reverberant field is naturally much lower than that of the reverberant field simulated by the rear loudspeakers in the listening area, the listener is enabled to reconstruct the reverberation phenomenon corresponding to the sound scene reproduced by the front loudspeakers essentially based on the audio signals coming from the two rear loudspeakers.

The transducers form an approximately symmetrical assembly with respect to a median vertical plane, which is also a mediating plane of the listening area for the listener. The listener is placed in an optimal manner when he is facing the front transducers 105, back to the rear transducers 107, his head in the listening area and the mediating plane of the sound reproduction system is also a mediating plane for the user.

The notion of symmetry is understood here relative to the precision of the adjustment and the implementation. Furthermore, by approximately symmetrical, it is meant that elements of decoration, wiring or other, not essential for the reproduction of sounds, can be non-symmetrical with respect to the median plane. For example, the position of the power supply of the sound reproduction system 100 is irrelevant for the quality of the reproduction of the sounds and may be outside the median plane.

The volume of the listening area is in this particular embodiment limited by the limitation of the horizontal distances between the various transducers. The listening area is thus of a limited volume but sufficient for a single listener, so that:
a. the position is naturally close to the ideal position without being constrained by rigid positioning elements which would make the use of the device uncomfortable.
b. the head of the ideally placed listener intercepts most of the beams emitted by the four transducers, so that listening is not impaired by undesirable reflections of these beams on the various elements of the sound reproduction system or of the room in which it is located, or by interference between these beams within the listening area itself.

4 Depending on the directivity of the beams, some of the sound beams may not be intercepted by the listeners head. But one understands that the quality of listening in the sound reproduction system 100 is all the better as the opening of these beams is well controlled. We can also consider adapting waveguides on one or more of the four transducers for this purpose.

According to one embodiment, the emission axes of the front loudspeakers 107 intersect at a point of intersection of the emission axes of the front loudspeakers 107. The front loudspeakers 107 are each delimited by a flat front face on the emission side and the point of intersection of the emission axes of the front loudspeakers forms with the points of intersection of the emission axes with the flat front faces of the two front loudspeakers an isosceles triangle whose equal angles are between 50° and 70°.

It has been observed that this range of configurations of the sound reproduction device 100 provides the listener with particular listening comfort, allowing him to be particularly well immersed in the sound emitted by the front loudspeakers 107.

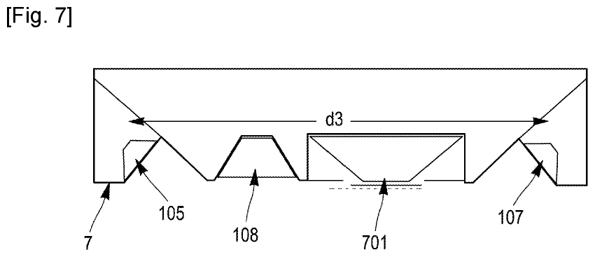

In one embodiment, each of the pairs of transducers of the sound reproduction system 100 is integrated into a housing 7, in which compartments are made to accommodate the front transducer 105 and rear transducer 107 of the pair of transducers. A housing 7 provided with a set of transducers is shown seen from above in FIG. 7.

The housing protects the transducers and facilitates their relative positioning and the positioning of each pair of transducers relative to the other pair of transducers.

The housing 7 further comprises all the electrical and electronic components necessary for the operation of the electroacoustic transducers.

One of the housings 7 (or the two housings 7) can include a technical zone 110 allowing the mechanical and/or acoustic adjustments of the sound reproduction system 100 to be made.

One or more walls of a housing 7 can be covered with acoustic insulating material. This arrangement makes it possible to partially isolate the listening area from parasite sound sources and from any uncontrolled reverberation phenomena on these walls.

In a particular embodiment, the compartments are configured in such a way as to limit the degrees of freedom of movement of the loudspeakers they contain. In particular, it is possible to leave only degrees of freedom in rotation, so that the inclination of the main emission axis of each loudspeaker can be adjusted where the reproduction system is placed.

In this way, the position of the listening area, in particular its height from the floor, can be adjusted, possibly depending on the listener.

A system for blocking the orientation of the loudspeakers after adjustment can be provided. Thanks to this arrangement, a preselection can be made by an operator, for example when mounting the loudspeakers on the housing, or even during the installation of the sound reproduction system 100 in a given place, and this adjustment will be allowed to be modified only by voluntary release of the blocking system.

In a particular embodiment, the greater of the two distances d1 and d2, the distance d1 being measured horizontally between the two front transducers and the median plane and the distance d2 being measured horizontally between the two rear transducers and the median plane, and the distance d3 measured in the front-to-rear direction between the front transducer 105 and the rear transducer 107 of each of the pairs of transducers are in a ratio of the order of 0.7.

The distances d1, d2, d3 are defined with respect to the center(s) of the membrane(s) of the loudspeaker(s) concerned.

Thanks to this arrangement, the listening area, in which the sound beams emitted by the four front and rear transducers intersect, has an optimal volume so that the listener has a feeling of enveloping sound.

In this way, the listening area is placed in an ideal manner with respect to the front loudspeakers in order to obtain listening that is little disturbed by the environment of the sound reproduction device 100.

The position of the listeners head that provides the most natural sound sensation is in the center of the listening area. The position of this center relative to the intersection of the straight lines joining a front transducer 105 and the rear transducer 107 on the opposite side can be adjusted by adjusting the ratio of the sound powers emitted by the rear transducers 107 compared to those emitted by the front transducers 105, but also by adjusting the delay of the sounds emitted by the rear transducers 107 relative to those emitted by the front transducers 105 which will be described later, as well as by adjusting transaurality.

The advantage of the sound reproduction device is that it leaves a certain latitude of positioning to the listener while maintaining a pleasant listening experience.

In particular, we note that the listener can be a little too far forward or behind this center, a little above or below this center, while maintaining a satisfactory listening sensation.

It is possible to provide the housing 7 with one or more support stand. In this way, the sound reproduction system 100 can be easily moved from one place to another if the support stand is not attached to any other object than the housing. The sound reproduction system 100 can thus also be placed at a certain height from the ground. 1 It can for example be adapted for a standing listener, in the center of a room or at least at a distance from the walls of this room.

Furthermore, the floor space requirement of the sound reproduction system is reduced.

This arrangement makes it possible, for example, to create, with several sound reproduction systems 100, a sound path with several quality listening areas that are independent of each other in a room such as a museum room.

The choice of the height of the support stand(s) determines the range of accessible heights for the listening area. It will thus be possible to create a sound reproduction system for a seated or standing listener, and for listeners of various sizes by choosing a support stand of height adapted to the desired use.

In a particular embodiment, the support stand is adjustable in height. This arrangement increases the flexibility of the adjustment of the sound reproduction system 100.

If, on the contrary, the sound reproduction system 100 is intended for a specific location near a wall or a partition, the housings 7 can in another embodiment be linked to this wall or this partition.

This arrangement makes it possible to not totally or not partially prevent the movement or positioning of objects or people on the floor due to the floor space requirement of the sound reproduction system 100.

For example, the housings 7 of a sound reproduction system 100 can be placed on either side of a screen, or of a painting in a museum, for a standing listener.

The housings 7 can also be placed on a wall or a headboard at the back of a bed to allow listening while lying down or leaning against the wall.

The wall can optionally be covered with an acoustically insulating material.

Thanks to this arrangement, listening is little disturbed by uncontrolled reverberation phenomena towards the rear of the listener or by parasite sound sources whose sound wave could propagate and reach the listener directly from behind.

The connection of the housings 7 to the wall or to the partition can, in a first variant, be of the embedding type, by means of screws for example.

This connection can, in a second variant, allow certain degrees of freedom of movement of the housings 7 with respect to the wall or to the wall. In particular, the housing 7 can be fixed to the wall by means of an articulated arm, which allows the adjustment of the position of the housing in depth relative to the wall, and/or the folding down of the housing 7 along the wall when the system sound reproduction 100 is not used.

Means for temporarily blocking the adjustment of the articulated arm can be provided.

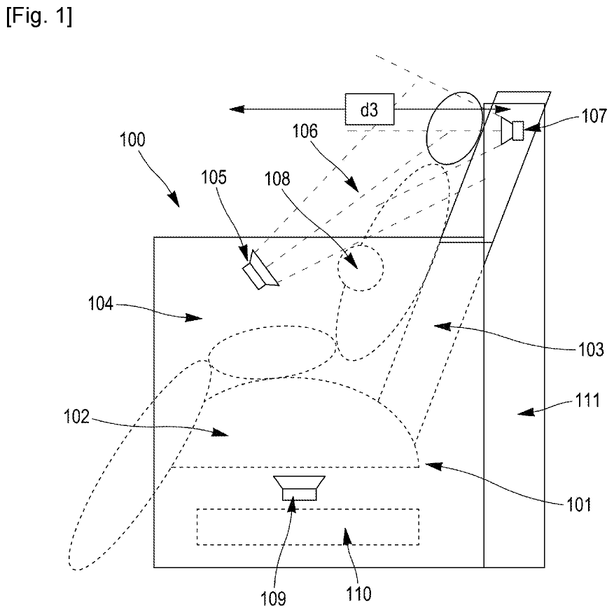

In a particular embodiment, the reproduction system 100 is adapted specifically to the seated position. In this case, it comprises, as shown in FIG. 1, a seat 101 comprising a seat base 102, optionally a backrest 103, optionally a rear wall 111 and optionally two side walls 104. All of these elements are approximately symmetrical with respect to a vertical plane, called the “median” plane of the sound reproduction system 100, or equivalently mediating plane.

In a particular embodiment, the two side walls 104 comprise the housings 7 or are formed by the housings 7.

Alternatively, the side walls 104 are armrests of a seat on which are placed two housings 7, optionally provided with support stands.

In this way, a seat that a listener already has can be equipped, at lower cost and possibly reversibly, with two housings 7 so as to constitute a reproduction system 100.

In particular, optional implantation inserts for supporting the housing, placed on the armrests, can allow stable, simple and quick installation on any type of seat and offer height adjustment around the listener.

Whatever the embodiment, the pairs of transducers are symmetrical to each other. As seen previously, the notion of symmetry is understood here relative to the precision of the adjustment and the positioning. Moreover, by approximately symmetrical, it is meant that elements of decoration of the seat, of wiring or other, not essential for the reproduction of sounds, can be asymmetrical with respect to the median plane. 3 For example, the position of the power supply of the sound reproduction system 100 is irrelevant for the quality of the reproduction of the sounds and may be outside the median plane.

The seat 101 is also equipped with a plurality of electroacoustic transducers receiving an electrical signal at the input and emitting a sound signal at the output.

The seat 101 further comprises all the electrical and electronic components necessary for the operation of the electroacoustic transducers.

The dimensions of the seat 102, of the backrest 103 and of the side walls 104 are fixed so that the head and neck of the majority of the users for whom the seat is intended are located in a so-called listening zone, above the highest edges of the side walls, the rest of the body being, at most up to shoulder height, framed by the backrest and the two side walls. The listening area is thus not framed by the side walls, which avoids the comb response at the level of the listeners head.

In a particular embodiment, the distance (d1) measured horizontally between the two front transducers and the middle plane and the distance (d2) measured horizontally between the two rear transducers and the middle plane and the distance (d3) measured along the direction front-to-rear between the front transducer and the rear transducer of each of said pairs of transducers are in particular in a ratio preferably of the order of 0.7.

The distances d1, d2, d3 are measured from the center of the loudspeaker membrane.

According to a particular embodiment, the height of the seat 102 and the inclination of the backrest 103 can be adjusted by the user or at least personalized according to the user of the seat.

The foams that make up the seat base 102, the side walls 104, the rear wall 111 and the backrest 103 preferably have a high alpha Sabine sound absorption coefficient in the range of audible frequencies, and more particularly in the range [500 Hz, 5000 Hz] in which the sensitivity of the ear is greatest.

The seat base 102, the side walls 104, the rear wall 111 and the backrest 103 are also preferably covered with acoustic fabrics, transparent to sound waves.

This arrangement makes it possible to limit the reflections of the sound waves emitted by the transducers on these various elements, so that the resulting sound wave perceived by the user is essentially made up of direct waves emitted by the transducers of the sound reproduction system 100.

In particular, in this embodiment, the waves emitted by the various transducers do almost not propagate outside the reproduction system 100, which limits the reverberation phenomenon linked to the listening room perceptible for the listener.

The vertical extension of the side walls 104 of the seat 101 approximately up to the users shoulder height also allows partial isolation of the listener from sound sources external to the sound reproduction system 100.

In the embodiment of FIG. 1, the sound reproduction system 100 comprises at least four electroacoustic transducers, including at least two front electroacoustic transducers 105, which are placed in recesses of the side walls 104 of the seat which constitute the housings 7, in front of the rear wall 111.

The shape of the recesses can participate in guiding the sound wave emitted by the transducers in the desired direction.

These transducers are in this embodiment, as well as possibly in the other embodiments, by way of non-limiting example, of the “source point” type, coaxial with mechanically aligned phase for the two channels corresponding to the different frequency ranges (bass/medium and treble), or broadband loudspeakers.

Mechanically phase-aligned coaxial speakers feature very high precision phase alignment between the two paths at the emitting end. Such loudspeakers are therefore close to a single point source.

In the embodiment described in FIG. 1, the listener is typically within one meter of the source. This unusual listening position has the second advantage of allowing near-field listening, so as to mask the reverberant field.

Comb filtering in the frequency ranges corresponding to the overlap between the different channels is very limited and the reproduced sound is of very good quality.

The front transducer 105 and the rear transducer 107 typically emit at least in the frequency range [100 Hz; 20 kHz].

In the case of “point source” transducers, the wave emitted from the loudspeaker is approximately spherical, so that the sound intensity is an inverse function of the square of the distance between the measurement point and the point source. The proximity of the listener to the transducers makes it possible to obtain satisfactory listening with a lower emitted sound intensity than when the listener is at a more usual listening distance (a few meters) from the loudspeakers, since the sound intensity decreases as the distance from the source increases.

The placement of the front transducers 105 in the front part of the side walls 104 of the embodiment of FIG. 1, consequently under the users head and in front of his trunk, allows the user to be outside the zone in which the waves emitted by the two front transducers as well as the waves reflected on the corresponding side walls significantly interfere. In other words, the user is outside the comb response zone, which allows for high-precision listening, faithful to the original sound to be reproduced. This modality can be implemented in other embodiments.

The placement of the two front transducers 105 in the side walls 104, so that they are oriented towards the head of the user also contributes to controlling the area of space in which the sound wave emitted by each of these transducers remains audible. Most of the sound intensity is distributed in a cone 106 with its apex at the source point and containing at least part of the users head.

In particular embodiments, the two front loudspeakers 105 are oriented so that their emission axes intersect at the level of the listeners frontal lobe, close to his vertical median plane.

The alpha angle then formed by these two emission axes may vary depending on the inclination of the backrest and/or the length of the side walls, but these parameters will be limited so that the alpha angle is between approximately 60° and 90°. In this case, the listener will perceive monophonic sounds (i.e., identical in phase and amplitude for two transducers symmetrical with respect to the median plane of the seat, for example sounds placed in the center during mixing operations) as emitted in the median plane of the seat, in front of him and not above him.

The frequencies best analysed by the human brain are between 500 Hz and 5 kHz. The ears of the listener must therefore be, if possible, in the axis of radiation of the loudspeakers emitting these frequencies. We therefore understand the interest, in order to obtain high listening precision, of constraining the positioning of the listener in relation to the various transducers, by linking the position of the latter and of the sea.

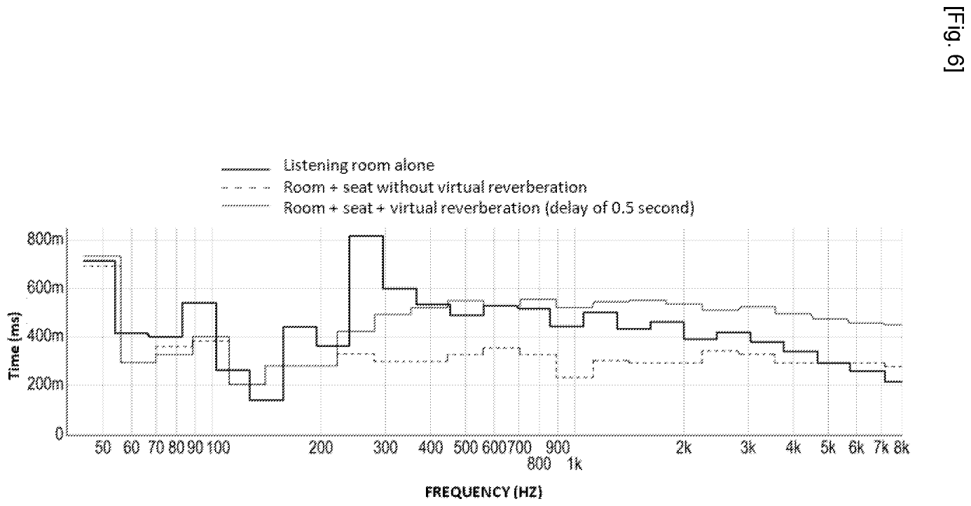

When the front transducers 105 are placed in the side walls 104 of a seat or in housings 7 placed so as to respect the constraints on the distances d1, d2 and d3 mentioned above, they are at a distance from the listener less than the critical distance for which the intensity of the free field, corresponding to the wave coming directly from the source, becomes equal to that of the diffuse field, corresponding to the multiple reflections of the initial sound wave. Below the critical distance, the free field predominates: the listener essentially perceives the direct sounds coming from the front transducers. The phenomenon of natural reverberation (which results, despite the partial acoustic insulation of the seat, from the propagation of a fraction of the sound emitted by the loudspeakers towards the outside of the seat) is largely masked by these direct sounds, as indicated in FIG. 6, and an essentially virtual reverberation could be created thanks to transducers other than the front transducers, which will be introduced later in this description. In other words, the phenomenon of reverberation perceived by the listener is essentially virtual and controllable.

FIG. 6 shows the influence of the sound reproduction system 100 according to the embodiment of FIG. 1 with activation of only the front transducers 105. 4 It can be seen that, with respect to the listener located at a given point in the room measurement, the reverberation phenomenon is much less dependent on the frequency in the presence of the sound reproduction system (gray and thick curve) than in the absence of this system (black and thicker curve). Without the seat, the reverberation time RT60 depends on the frequency, which means that the spectrum of the signal perceived by the listener will not be identical to the spectrum of the emitted signal. Listening is impacted by the room in which it is performed. In the presence of the reproduction system, the phenomenon of reverberation exists but is not very dependent on the frequency; it thus modifies all the frequencies of the signal approximately in the same way: the sound is perceived by the listener with a spectrum that is not very distorted compared to the emission spectrum.

Near-field listening has the added benefit of reducing noise pollution. Typically a conventional sound reproduction system placed two meters from the listener would require a sound intensity 10 dB higher acoustically at the source for the same perception by the listener than when placed in the seat equipped with the system sound reproduction described in this document.

Concomitantly, the reduction of the sound intensity at the level of the sources compared to a conventional system for the same sound intensity perceived by the listener makes it possible to reduce the rate of harmonic distortion and therefore to increase the fidelity of the sound perceived by the user.

The sound reproduction system 100 described here makes it possible, for example, to obtain a sound restitution power of the order of 100 dB in terms of sound pressure level (dB SPL) with a harmonic distortion rate of less than 3% for the listener for frequencies above 60 Hz.

Specific waveguides can optionally be added to the output of each of the front transducers to better control the angle at the top of this cone.

Thanks to these provisions, an appropriate adjustment of the distance between two consecutive seats and of the maximum sound powers emitted by the transducers, as well as possibly of the shape of the waveguides, also allows a relative separation of two contiguous seats: the user of a given seat will almost only perceive the sound corresponding to the transducers fitted to his own seat. In particular, the sound power emitted in the low frequency range is adaptable to each seat so as to be able to control the overall intensity of the low frequencies in the room, for which the effect of physical coupling with the room is particularly sensitive, in the case where the different seats simultaneously reproduce the same sound.

The two front transducers 105 each receive an audio signal as input and emit a sound signal as output.

The audio signals at the input of the two front transducers 105 are the audio signals as recorded, or else having undergone, by means of a digital signal processor, a processing step in order to correct the non-linearity of the front transducers.

In a particular embodiment, the audio signal corresponding to the recording to be reproduced is not directly sent to the input of the front transducer considered, but it constitutes the input signal of a digital signal processing system (DSP) dedicated to the front transducers 105. The digital signal processor filters this input signal, in particular to correct the linearity defects of the front transducers. The audio signal at the output of the digital signal processing system constitutes the audio input signal for the front transducer 105 concerned.

The digital signal processing system can for example be placed in the housing 7 or in a side wall 104 or a technical area 110.

At the level of the front transducers 105, whose frequency response is not perfectly linear given the modification of acoustic impedance brought about by the recesses guiding the wave, this filtering step aims to obtain a reproduced direct field as faithful as possible to the recorded sound signal.

In one embodiment, for each of the channels of the front transducers 105, an amplification device can be inserted between the digital signal processing system and the front transducers 105.

In the embodiment shown in FIG. 1, at least two other rear electroacoustic transducers 107 are placed in or above the upper part of the rear wall 111, approximately at user ear height, on both sides of the user, so that they are symmetrical to each other with respect to the median plane of the seat.

The rear transducers are oriented so that the emission axis of each of these transducers passes close to the user's ear that is on the same side of the median plane of the seat as the transducer.

These two transducers 107 emit sound signals having frequencies typically included at least in the range [100 Hz; 20 kHz].

In all the embodiments, the audio signal at the input of each rear transducer 107 is generated thanks to a digital signal processing system (Digital Signal Processor, DSP) dedicated to these two rear transducers. Depending on the embodiment, the digital signal processing system can for example be placed in the housing 7 or in a side wall 104 or a technical area 110.

Each transducer 107 receives an electrical input signal which is calculated with respect to the electrical input signal of the transducer 105 located on the same side of the median plane of the seat.

If a digital signal processing system has been dedicated to the front transducers 105, the audio signal at the input of this signal processing system constitutes the input signal for the signal processing system dedicated to the rear transducers 107.

In the two embodiments (with or without a digital signal processing system dedicated to the front transducers 105), the notion of stereophony is retained for all of the front and rear transducers.

In one embodiment, a broadband amplifier device can be inserted between the digital signal processing system dedicated to the rear transducers and the rear transducers 107.

In one embodiment, the digital signal processing system and the electronic components necessary to generate the electrical signal at the input of the rear transducers are placed in a technical area 110 under the seat base 101.

As a variant, in the case where a room is equipped with several sound reproduction systems 100, all the technical zones of the different sound reproduction systems 100 can be grouped together in a single technical zone distinct from the sound reproduction systems 100.

The electric signal to be supplied at the input of the rear transducers 107 is calculated from the electric signal supplied at the input of the front transducers 105, so as to create a virtual reverb effect.

In particular, the electric signal at the input of each rear transducer 107 is delayed compared to the electric signal at the input of the front transducer 105 from which it is calculated.

The delay is the sum of two terms:
the first term is constant and determined according to the geometry of the seat. It takes into account the difference in positioning of the front transducer and the corresponding rear transducer with respect to the listening area. 6 In the presence of this term alone, the waves emitted by a given front transducer and the corresponding rear transducer are in phase at the center of the listening area;
the second term can be adjusted by the user or an operator, for example by means a potentiometer. 3 The delay can for example be set in the range [0 s; 5 s], the range [0.3 s; 0.7 s] giving a satisfactory perception for most sound scenes.

We will understand the influence of the second term using FIG. 6. 3 In this figure, we have already seen above that, in the presence of the seat but without activation of the rear transducers 107, the RT60 is an almost constant function of the frequency for frequencies above 100 Hz. It is of the order of 0.3 s for the seat tested in the test room.

2 The reverberant field generally depends on the geometric and acoustic characteristics of the listening room. On the contrary, the sound reproduction system 100 makes it possible to obtain a reverberant field which is virtually reconstituted and as constant as possible in frequency: as the listener is placed close to the various transducers, and thanks to the various elements of the sound reproduction system 100, there remains a real reverberant field which, as already seen in FIG. 6, was very little dependent on the frequency The delay, of the order of 300 ms, is sufficient for this real reverberant field not to be confused with the direct field by the listener, who therefore perceives an enveloping sound but little distorted compared to the direct sound. The rear transducers 107 will then make it possible to create a controlled virtual reverberant field thanks to the adjustable delay.

The effect of the delay can be seen on the thinner gray curve in FIG. 6 In the case presented here, a second term has been added to the first constant term, so as to obtain a delay of 0.56 s between the signal emitted by the rear transducers and the signal emitted by the corresponding front transducers. We can see that this delay is actually obtained with an entirely satisfactory precision in the range [500 Hz, 5 kHz] corresponding to the maximum sensitivity of the human ear.

A short delay will be more suitable for reproducing a sound produced by an instrument such as drums, while a long delay will be more suitable for reproducing a sound produced by an organ. A high delay will in particular give a sound that dies out more slowly, and therefore provide a more “enveloping” sound sensation than a low delay.

In one embodiment, as seen above, a second digital signal processing (DSP) system is dedicated to the rear transducers 107. This second DSP makes it possible to control the sound coloration of the reverberant field, so that it best reproduces that of the chosen room, for example the one where the recording was made.

For this purpose, various parameters can be adjusted by intervention on the DSP, for example on the technical area 110. The sound coloration can be chosen from the digital parameters supplied to the digital signal processing system. For example, the amplitude and/or the phase of the reverberated wave can be modulated according to the frequency to obtain the desired coloration.

It is for example possible to predefine one or more sound signatures associated with one or more given rooms at the level of the technical area. In this case, the technical zone contains a memory able to store the parameters characterizing these sound signatures and to transmit them to the DSP controlling the sound coloration of the reverberant field.

The sound intensity of the reverberant field can also be adjusted at the level of the technical area.

Adjusting all of these parameters makes it possible to obtain acoustics adapted to the type of sounds listened to by the listener, for example acoustics close to a concert hall for a symphony orchestra, or adapted to a rock music concert, etc.

The sound reproduction system 100 is thus suitable both for work in a recording studio—such as the editing or mixing of sound documents—and for recreational listening or even for cinemas or video games.

As a variant, the sound reproduction system 100 can be adapted to listening to sounds obtained by multi-channel mixing. The number of front 105 and rear 107 transducers is then adapted to the number of channels, the relationship between the signals emitted by each front transducer 105 and the corresponding rear transducer 107 being managed in the manner described in the preceding paragraphs.

In the case of cinema room equipment according to the embodiment represented in FIG. 1, this sound reproduction system 100 allows listening of the same quality regardless of the positioning of the seat in the room, whereas with the sound reproduction systems commonly used, only listeners located in the axis of the sound diffusion system perceive the sounds that were centred on this axis during the mixing as coming from a point on this axis.

In a particular embodiment, as seen above, the sound reproduction system 100 has neither a base nor a backrest but has side walls 104 and can for example be positioned so as to be used by a standing listener.

In a particular embodiment, in particular in a noisy environment, such as a public place or an exhibition hall, an upper wall covered with an acoustic insulating material forming a roof over the head of the user can be added to the sound reproduction system so as to further isolate the listener from sounds other than those emitted by the transducers fitted to the system. Depending on the embodiment, this wall can be fixed on the housings 7, a rear wall 111 or even a wall if necessary.

In a particular embodiment, two additional electroacoustic transducers 108 emitting in the low frequency range (for example between 20 Hz and 500 Hz, or even between 20 Hz and 150 Hz) are placed in the housings 7, approximately as close as possible to the users ears. This close proximity to the listeners ears allows to mask the reverberant field at low frequencies, which is particularly tricky due to the long wavelengths of the corresponding sound waves. It makes it possible to recover the nuances of the low frequencies present in the recording, which are lost if, on the contrary of what is proposed in the invention, the listener is moved away from the source, the loss being all the more important as the source-listener distance increases.

Since the 108 transducers are dedicated to low frequencies and therefore to long wavelengths, they can be placed closer to the listener than the 105 transducers. Moreover, the location of the source of the low frequencies being of low precision for the listener, the height of the transducers 108 in the boxes 7 is irrelevant for the quality of the listening.

A DSP is connected to the additional transducers 108, so that each additional transducer 108 receives as input the low frequency components of the audio signal at the input of the front transducer 105 which is located on the same side of the median plane, on which a delay has been applied so that the waves emitted by a given frontal transducer and the additional transducer 108 located on the same side of the listener are perceived in phase at the listening point.

The signal at the input of each additional transducer 108 is also low-pass filtered, freeing the front transducers of these low frequencies at the crossover frequency. The front transducers 105 then have high-pass filtering forming a symmetrical acoustic target, as defined by the general transfer functions of the Linkwitz-Riley, Bessel, Butterworth type, with acoustic orders which can vary from 2 to 12, for example an order 4.

Dedicating additional transducers 108 to low frequencies makes it possible to limit the electrical power to be supplied to the front loudspeakers 105 and thus the distortion at the level of the latter, by relegating the lowest frequencies to subwoofers whose Thieles/Small settings are suitable for this purpose.

The additional transducers 108 can finally have a phase adjustment (traditional stereophony) or a partially or totally inverted phase adjustment between them to benefit from the work of David Gresinger (acoustical society meeting in Vancouver, May 2005).

In a particular embodiment, an electroacoustic transducer 109 emitting in the infra-bass range, that is to say at frequencies below 20 Hz, is placed in the seat base to complete the sound environment created by the reproduction of sounds 100.

As with the front transducers, a digital signal processing device to correct the linearity defects of each of the additional 108 and/or sub-bass 109 transducers, as well as an amplification device at the output of the digital processing device can be implemented in a particular embodiment.

Last, in a particular embodiment, a video screen 201 can be placed facing the listener, through which the user can for example view video content, in particular films or audiovisual recordings of concerts, and/or adjust some of the parameters of the sound reproduction system 100.

### REFERENCE SIGNS

100: sound reproduction system
101: seat of a sound reproduction system 100 comprising a seat
102: seat base of a seat 101
103: backrest of a seat 101
104: side wall of a sound reproduction system 100
105: front loudspeaker
106: main emission axis of a front loudspeaker 105
107: rear loudspeaker
108: low frequency transducer
109: infra-bass transducer
110: technical area
111: rear wall of a reproduction system 100
210: screen
7: housing
701: passive resonator

1-27. (canceled)

28. Sound reproduction system wherein the sound reproduction system comprises at least four electroacoustic transducers each receiving an audio signal and converting it into a sound signal, and comprising a listening area for a single listener, characterized in that:
two of said four transducers, called front transducers, are placed symmetrically to each other with respect to a median vertical plane, and oriented so as to each emit a sound wave towards the listening area,
two of said four transducers, called rear transducers, are placed symmetrically to each other with respect to said median vertical plane and oriented so as to each emit a sound wave towards the listening area,
the four transducers, front and rear, thus form two pairs of transducers symmetrical to each other with respect to the median vertical plane, each pair of transducers comprising a front transducer and a rear transducer,
the single listener being to be placed facing the front transducers and back to the rear transducers.

29. Sound reproduction system according to claim 28, characterized in that:
each of the four transducers is a directional sound source characterized by a main axis of emission that is secant with said median vertical plane,
for each of said pairs of transducers, the sound signal emitted by said rear transducer simulates a reverberant field corresponding to said sound signal emitted by the front transducer,
the four transducers are included in a parallelepiped volume having a width of less than 200 cm, a length of less than 200 cm and height less than 200 cm,
and the distance measured horizontally between the pairs of transducers is greater than the distance measured horizontally between the two ears of the single listener.

30. Sound reproduction system according to claim 29, characterized in that said emission axes of the front loudspeakers intersect at a point of intersection of the emission axes of the front loudspeakers, in that the front loudspeakers are each delimited by a flat front face on the emission side and in that the point of intersection of the emission axes of the front loudspeakers forms with the points of intersection of each of the emission axes of each front loudspeaker with the flat front face of this front loudspeaker an isosceles triangle which equal angles are between 50° and 70°.

31. Sound reproduction system according to claim 29, characterized in that each of the said pairs of transducers is integrated in a housing comprising one or more recesses in which the front and rear transducers of the pair of transducers are placed, and of which at least a part of the walls is covered with an acoustically insulating material.

32. Sound reproduction system according to claim 31, characterized in that each of the said housings is mounted on at least one support stand, optionally adjustable in height.

33. Sound reproduction system according to claim 28, characterized in that it further comprises:
a rear wall, and
two side walls, extending in depth in front of the rear wall and in height to a height lower than that of the upper edge of the rear wall and each comprising at least one recess so that the walls each form a housing in which one of the pairs of transducers is placed,
the rear wall and the side walls constituting a symmetrical assembly with respect to said median vertical plane,
the listening area corresponding to the empty volume being between the side walls at a height higher than that of the upper edges of the side walls and lower than that of the upper edge of the rear wall,
the front transducers each emitting a sound wave towards the listening area in a emission cone entirely intercepted by the listener's head placed in the listening area and/or by the rear wall and/or by the side walls, and
the rear transducers each emitting a sound wave towards the listening area in an emission cone entirely intercepted by the listener's head placed in the listening area and/or by the side walls.

34. Sound reproduction system according to claim 32, characterized in that the front transducers are placed at a distance from the listener enabling the listening of the direct field of these frontal transducers, i.e. a distance less than the critical distance for which the intensities of the direct field and the diffuse field are equal.

35. Sound reproduction system according to claim 31, characterized in that at least one of the housings (7) comprises a device for constraining in a fixed or adjustable manner the orientation of the axis of emission from at least one of said four transducers.

36. Sound reproduction system (100) according to any claim 31, characterized in that it comprises a seat (101) comprising at least one seat base (102), optionally covered at least partially with a sound-insulating material, so that the listening area is above said seat (102) and each of the housings (7) is linked to said seat (101).

37. Sound reproduction system (100) according to claim 36, characterized in that the seat (101) further comprises armrests to which the housings (7) are attached, optionally in a removable manner.

38. Sound reproduction system according to claim 31, characterized in that the housings are linked, optionally in a removable manner, to a wall of a building forming a rear wall, optionally covered with a material acoustically insulating, the housings being optionally foldable down against the rear wall when they are not used for the reproduction of sounds.

39. Sound reproduction system (100) according to claim 28, characterized in that the distance between the single listener and the front transducers (105) is less than 1 m.

40. Sound reproduction system (100) according to claim 28, characterized in that it comprises at least one signal processing device, so that an audio signal received by the rear transducer of each pairs of transducers is generated by means of the at least one signal processing device from the same audio signal as that from which an audio signal received by the front transducer of the pair of transducers is formed, said audio signal received by the rear transducer of each of the pairs of transducers being delayed relative to said audio signal from which said audio signal received by the front transducer of the pair of transducers is formed.

41. Room equipped with a plurality of sound reproduction systems according to claim 28.

42. Housing comprising one or more compartments suitable for receiving at least the front transducer and the rear transducer of one of the pairs of transducers of a sound reproduction system according to claim 31.

43. Sound reproduction system according to claim 33, characterized in that the front transducers are placed at a distance from the listener enabling the listening of the direct field of these frontal transducers, i.e. a distance less than the critical distance for which the intensities of the direct field and the diffuse field are equal.
